(19) United States
(12) Patent Application Publication
(10) Pub. No.: US 2002/0194127 A1
(43) Pub. Date: Dec. 19, 2002

(54) Method and system for processing invoices

(76) Inventors: Wayne L. Randell, Oakville (CA); Leonard A. Podgurny, Mississauga (CA); Edward A. Widlake, Grimsby (CA)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/845,396

(22) Filed: Apr. 30, 2001

(51) Int. Cl. G06F 17/60

(52) U.S. Cl. 705/40; 705/39

(57) ABSTRACT

A method and system for electronically presenting and granting payment of invoices offering multi-stage invoice handling capability is provided. An invoice is generated at a biller entity and is made electronically available to a customer entity. Users associated to the customer entity are enabled to complete respective stages of a multi-stage invoice handling process. The users transmit data elements indicating that respective stages of the multi-stage invoice handling process have been completed. Granting of payment of the invoice is detected at the biller when the data elements are received at the biller and indicate that the multi-stage invoice handling process has been completed.

### FIELD OF THE INVENTION

This invention relates to a system and method for facilitating online commerce over a public network such as the Internet or an interactive T.V. cable network. More particularly, this invention relates to a system and method for conducting online processing of an invoice including multi-stage invoice handling capabilities.

### BACKGROUND OF THE INVENTION

Online commerce has experienced dramatic growth in recent years and this growth is expected to continue into the coming decades. Internet service providers are, more and more, connecting users to the Internet at no cost, thus eliminating barriers to an Internet connection. At the same time, merchants are increasingly developing sites on the World Wide Web (or simply “WWW” or “Web”) that customers can access to order goods and/or services. It is now fairly common for a customer to browse a merchant's catalogue, select a product or service and place an order for the product/service all electronically over the Internet. Similarly, it is becoming increasingly common for merchants to allow payment of invoices electronically. Typically, the invoice is sent electronically to the customer via electronic mail or made available to the customer over a network by providing the customer with network access capability.

U.S. Pat. No. 6,128,603 issued to Dent et al. on Oct. 3, 2000) describes a consumer-based system for analyzing, managing and paying electronic bill statements received from a biller. The biller electronically transmits a customized statement to a consumer's computer terminal over the Internet. The biller's electronic bill is presented to the consumer through a user interface. After reviewing the electronic bill the consumer can enter how much of the bill to pay, from which account to pay from, and the desired payment date. The entered information is then transmitted to the biller for processing. The contents of U.S. Pat. No. 6,128,603 are incorporated herein by reference.

Similarly, U.S. Pat. No. 6,070,150, issued to Remington et al. on May 30, 2000, describes an electronic payment system in which a biller electronically transmits a bill to a consumer over the Internet. The bill may arrive at the consumer's terminal via email or a notification for the consumer to check a billing mailbox. The consumer receives the bill that can be displayed in the form of a user interface. After reviewing the bill the consumer is able to enter the amount to be paid, the date of payment and from which account the money can be taken. The system described in Remington et al. also includes the ability to let the consumer dispute an item in an invoice. The contents of U.S. Pat. No. 6,070,150 are incorporated herein by reference.

A deficiency with the above-described systems for the payment electronic of invoices is that they are ill suited to certain business-to-business environments. In a typical business setting, it is not uncommon for several people to be involved at different stages in the handling of an invoice such as, for example, a division manager, a clerk in the accounts payable department and the manager of the accounts payable department. In these situations, the invoice is typically printed at the division manager's office, approved by the division manager and forwarded by internal mail (or e-mail) to the accounts payable department where one or more individuals authorize the payment to be made. This process is time consuming and often results in delays in the payment of an invoice.

Consequently there exists a need in the industry to provide an improved system and method for processing invoices that alleviates at least in part the deficiencies of prior art systems and methods.

### SUMMARY

In accordance with a broad aspect, the invention provides a method for electronically presenting and granting payment of invoices. The method includes generating an invoice at a biller and making the invoice electronically available to a customer entity. A first user associated to the customer entity is enabled to approve the invoice and a second user associated to the customer entity is enabled to authorize payment of the invoice, the second user being distinct from the first user. A data element indicating that payment of the invoice has been approved is transmitted from the first user to the biller. Another data element indicating that payment of the invoice has been authorized is transmitted from the second user to the biller. The granting of payment of the invoice is detected at the biller when payment of the invoice has been approved and authorized.

An advantage of the present invention is that it allows a customer entity to obtain account information without interacting with a person at the biller's location.

Another advantage of the present invention is that it facilitates the involvement of several individuals in the handling of an invoice.

Another advantage of the present invention is that it allows for at least two individuals to be consulted at different stages of the payment of an invoice such as at the approval stage and at the authorization stage. It will be readily appreciated that more than two stages may be present and more than two individuals may be involved in the handling of an invoice without detracting from the spirit of the invention.

In a specific implementation, the data element indicating that payment of the invoice has been approved and the data element indicating that payment of the invoice has been authorized are transmitted to the biller independently from one another.

Advantageously, this provides the biller with information regarding the stage of the payment of the invoice. This is particularly advantageous and allows the accounts receivable department at a biller site to readily determine at which stage an unpaid invoice is being delayed and to determine which person of the customer location to contact.

In a non-limiting example of implementation, the second user associated to the customer entity is enabled to authorize payment of the invoice subsequent the data element indicating that payment of the invoice has been approved is received at the biller.

Advantageously, this allows the order in which the stages of the invoice handling process to be effected in a desired order namely the invoice has to be approved prior to being authorized.

The users associated with the customer entity may be resident in a same location, such as a single office or multiple offices in a same building, as well as may reside in geographically remote locations. For example, the first user may reside in New York, N.Y., USA while the second user may reside in Vancouver, B.C., Canada. The first user has payment approval privileges and the second user has payment authorization privileges.

In a specific example of implementation, the invoice is electronically transmitted over a network. In a first non-limiting example of implementation, the invoice is transmitted via e-mail to the first and second users at the customer entity. In this implementation, the invoice is provided as a data structure including an approval field and an authorization field, the approval and authorization fields being modifiable by the first and second users respectively. In a non-limiting example, a field is provided allowing the second user to provide payment remittance information credit card information, an authorization to debit a bank account, wire transfer information, direct deposit information or an indication that a check will be mailed.

In a second specific example of implementation, the invoice is electronically transmitted over the Internet. In a non-limiting example of implementation, in order to view invoices and other account information, the users associated with the customer entity log on to a secure web-site using login names and associated passwords. The account information is displayed on a graphical user interface on the customer's computer terminal. Unpaid invoices are displayed with an approval field and an authorization field. The approval and authorization fields are modifiable by the first and second users respectively where the first user has payment approval privileges and the second user has payment authorization privileges. In a non-limiting example, a field is provided allowing the second user to provide payment remittance information including credit card information, an authorization to debit a bank account, wire transfer information, direct deposit information or an indication that a check will be mailed.

In accordance with another broad aspect, the invention provides a computer readable medium including a program element executable by a computing apparatus for implementing the above described method.

In accordance with a broad aspect, the invention provides a system implementing the above-described method.

In accordance with another aspect, the invention provides a method for granting payment of an invoice over a network, the invoice having been issued by a biller entity to a customer entity. The method includes transmitting over the network to the biller entity an approval status data element associated to the invoice from a first user associated to the customer entity. The method also includes transmitting over the network to the biller entity an authorization status data element associated to the invoice from a second user associated to the customer entity. Payment of the invoice is granted by the customer entity if the approval status data element indicates that the invoice has been approved and the authorization status data element indicates that the invoice has been authorized.

In a specific implementation, the first user has payment approval privileges, the payment approval privileges being assigned by the customer entity. The second user is distinct from the first user and has payment authorization privileges, the payment authorization privileges being assigned by the customer entity.

In accordance with another aspect, the invention provides a method for handling an invoice over a network, the invoice having been issued by a biller entity to a customer entity. An approval status data element associated to the invoice is received over the network at a biller entity. An authorization status data element associated to the invoice is received over the network at a biller entity. The biller detects the granting of payment of the invoice if the approval status data element indicates that the invoice has been approved and the authorization status data element indicates that the invoice has been authorized.

In a non-limiting example, payment of the invoice is expected at the biller entity when the granting of payment of the invoice has been detected.

In a specific implementation, the approval data element is associated to a first user. The approval status data element and an identifier associated with the first user are processed to determine if the first user has payment approval privileges. The detection of the granting of payment is prevented if the first user does not have payment approval privileges. Similarly, the authorization status data element is associated to a second user. The authorization status data element and an identifier associated with the second user are processed to determine if the second user has payment authorization privileges. The detection of the granting of payment is prevented if the second user does not have payment authorization privileges.

In accordance with a broad aspect, the invention provides a computer readable medium including a program element executable by a computing apparatus for implementing the above described method.

In accordance with a broad aspect, the invention provides a method for electronically presenting and granting payment of invoices. An invoice is generated at a biller and making the invoice electronically available to a customer entity. A plurality of users associated to the customer entity are enabled to complete respective stages of a multi-stage invoice handling process and transmit data elements indicative that the respective invoices processing stages have been completed. Granting of payment of the invoice is detected at the biller when the data elements indicative that respective invoice processing stages have been completed are received at the biller.

In a non-limiting example of implementation, the multi-stage invoice handling process includes a first stage and a second stage. A first user is enabled to complete the first stage and a second user is enabled to complete the second stage subsequent the data element indicating that the first has been completed is received at the biller.

Advantageously, this allows the stages of the invoice handling process to be effected in a desired order.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

FIG. 1 is a block diagram of an electronic invoice presentment and payment remittance system in accordance with an embodiment of the invention, including a biller computing system 116, a network 106, and a customer computing system 150 having a plurality of computing units;

FIG. 2a is a block diagram depicting one of the customer computing units shown in FIG. 1 in accordance with an embodiment of the invention;

FIG. 2b is a block diagram depicting the biller computing system 116 shown in FIG. 1 in accordance with an embodiment of the invention;

FIG. 3 is a flow diagram of a registration phase for use in connection with a process for electronically presenting and granting payment of invoices in accordance with an example of implementation of the invention;

FIG. 4 is a flow diagram of the process for electronically presenting and granting payment of invoices in accordance with a specific example of implementation of the invention;

FIG. 5a and 5b is a non-limiting example of implementation of a graphical user interface for presenting a plurality of unpaid invoices associated to a customer entity.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

The method and system for processing invoices provide multi-stage invoice handling capabilities. The multi-stage invoice handling process allows different users associated to a customer entity to be given different responsibilities in the handling of an invoice. In the example described, the multi-stage invoice handling process includes two stages, namely an approval stage wherein an invoice is approved for payment by a person permitted to do so, followed by an authorization stage wherein the actual payment is authorized to be made under the authority of a second person permitted to do so. It will be appreciated that a multi-stage invoice handling process having in excess of two stages remains within the scope of the invention.

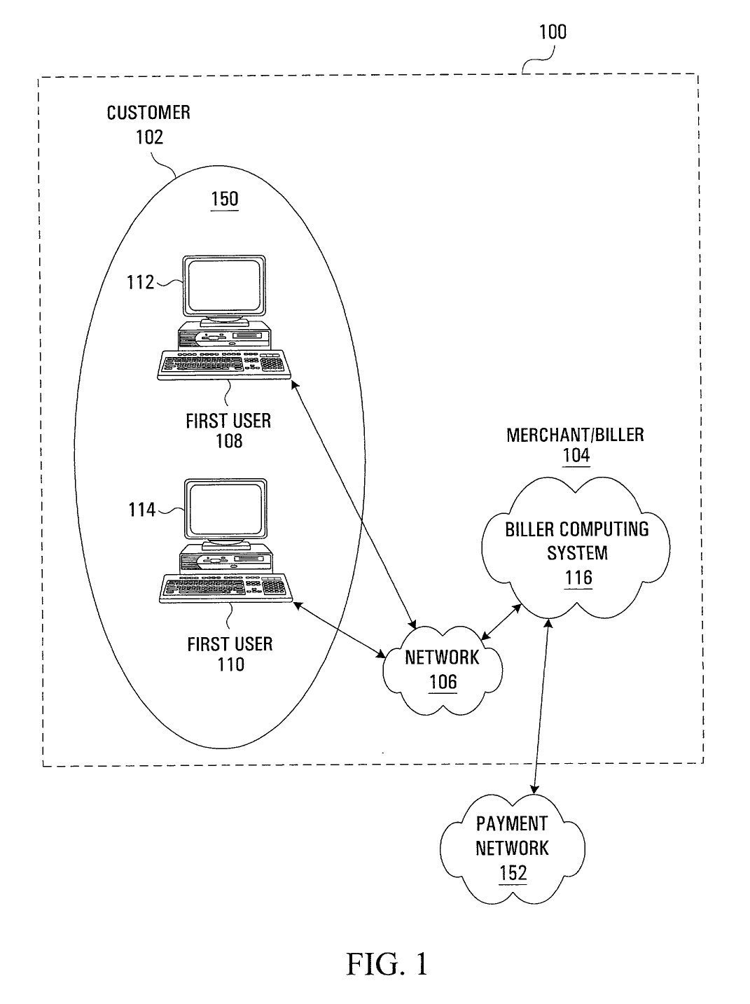

FIG. 1 shows an electronic invoice presentment and payment remittance system 100 in accordance with a specific implementation. The system 100 allows a customer entity 102 to view the state of its accounts payable with regards to a specific biller 104 and to issue payment instructions to that specific biller 104. The system 100 also allows the specific biller 104 to receive information regarding the payment stage of a certain invoice. The system 100 includes a biller computing system 116 and a customer computing system 150 interconnected through a network 106. The biller computing system 116 and the customer computing system 150 include tools for facilitating online commerce transactions between the customer entity 102 and the biller entity 104.

The network 106 is a data communication network interconnecting the customer computing system 150 and the biller computing system 116. In a specific example of implementation, the network is a public network. In the illustrated implementation, the data communication network 106 is embodied in the Internet. It is to be noted that the data communication network 106 may be implemented as a network other that the Internet such as an interactive television (ITV) network, a private network such as an Intranet or any other suitable network.

The customer computing system 150 comprises a plurality of computing units 112 114, each associated to a respective user 108, 110. The computing units 112 114 are generally in the form of personal computers, although other types of computing units may be used including laptops, notebooks, hand-held computers, set top boxes, and the likes. The plurality of computing units 112 114 may be connected to one another over an Intranet or may be stand-alone computing units. Each of the computing units 112 114 is provided with a connection to the network 106. The connection may be a permanent connection through a server at the customer's premises, or alternatively, a given computing unit may occasionally connect to the network 106 through the use of a dial-up connection using suitable devices such as a modem for example. For the purpose of simplicity, the example described herein below considers a customer computing system 150 including two customer computing units 112 114 each being respectively associated to a first user 108 and a second user 110. It will be readily appreciated that a customer computing system 150 including in excess of two customer-computing units remains within the invention.

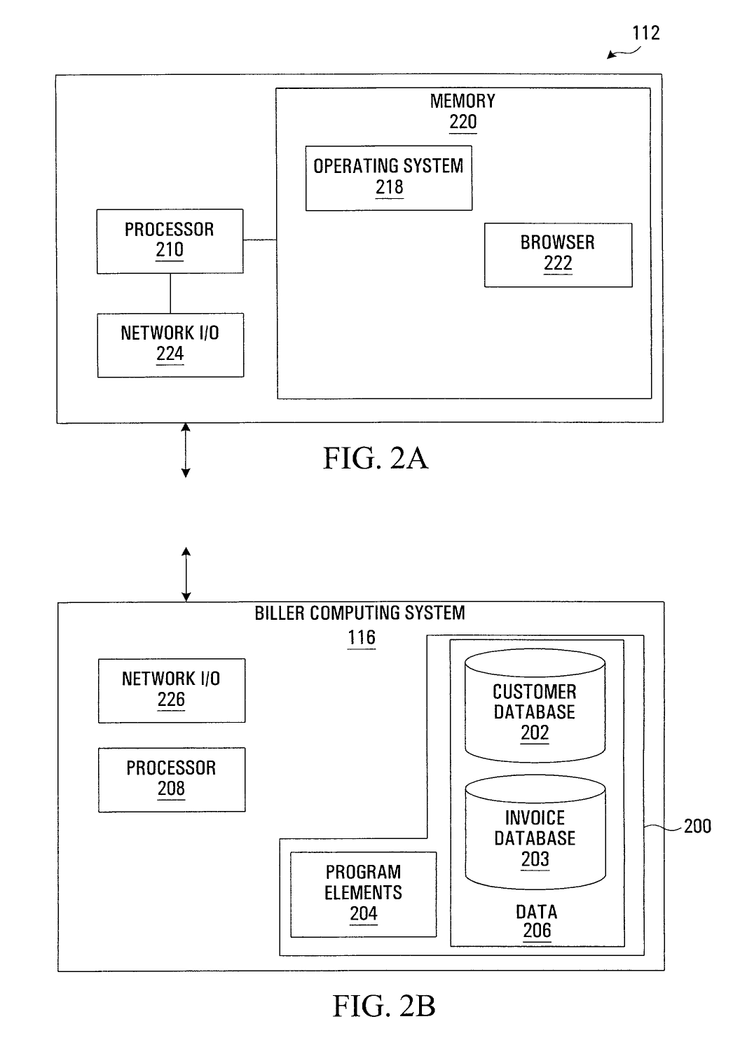

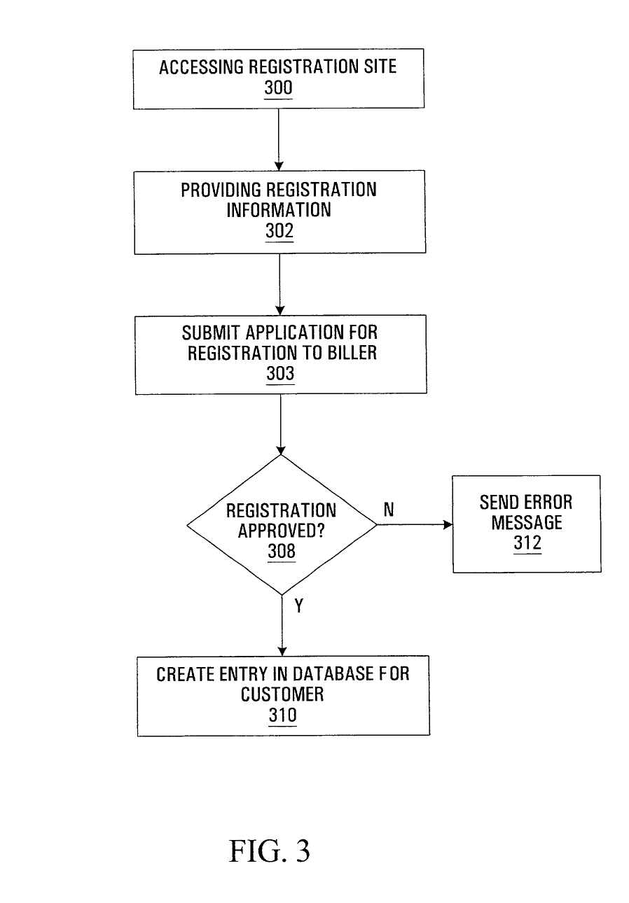

FIG. 2a depicts a block diagram of customer computing unit 112. The structure and functionality of customer computing unit 114 is identical to that of customer computing unit 112 and as such will not be described. As shown, the customer computing unit 112 comprises a processor 210, a memory 220 and a network I/O 224 (input/output) for accessing the network 106. The network I/O 224 can be implemented, for example, as a dial-up modem or as a permanent network connection. The processor 210 is adapted to execute program elements stored in the memory 220 for performing certain functions. More specifically, the customer computing unit 112 runs an operating system 218 that supports multiple applications. The operating system 218 is preferably a multitasking operating system that allows simultaneous execution of multiple applications in a graphical windowing environment. The memory 220 also includes a browser program element 222. The browser program element 222 when launched is executed by the processor 210 atop the operating system 218. The customer computer unit 112 may also include e-mail software components (not shown) as well as additional components and modules. These have been omitted from the description for the purpose of clarity.

The biller computing system 116 includes one or more computer servers and one or more computing apparatuses. The system includes program elements allowing the biller entity 104 to manage customer invoices and to provide electronic processing of invoices. The biller computing system 116 may also include modules for connection to a payment network 152 (shown in FIG. 1). The payment network 152 represents existing networks that presently accommodate transactions for credit cards, debit cards, checks and other types of financial payment processes. A description of the payment network 152 and of the interaction of the biller computing system 116 with the payment network 152 is not necessary for the understanding of the present invention and as such will not be described.

FIG. 2b shows a block diagram depicting a schematic diagram of the biller computing system 116. As depicted, the biller computing system 116 comprises a processor 208, a memory 200 and a network I/O 226 (input/output) for connection to the network 106. The network I/O 226 is preferably implemented as a permanent network connection although dial up connections may be suitable in certain embodiments. For example, if the biller computing system 116 interacts with the customer computing system 150 via e-mail, then a dial-up connection may be suitable.

The processor 208 is adapted to execute program elements 204 stored in the memory 200 for performing various functions. The memory 200 also has a data portion 206 including a customer database 202 and an invoice database 203. It will be readily appreciated that the biller computing system 116 may include additional components and modules. These have been omitted from the description for the purpose of clarity.

The customer database 202 includes information pertaining to the customers of the biller entity. In a non-limiting implementation, for each customer entity, an entry is provided including various information data elements associated to the customer entity. Amongst others, each entry includes a plurality of records, each record including a user identifier with a corresponding password. In addition, each user identifier is associated to respective privileges defining stages which the user is permitted to complete. In a specific example, the customer database includes a first user having payment approval privileges and a second user having payment authorization privileges. The table below is a representation of an entry in the customer database for customer ABC INC. As shown, ABC INC. has five records for users (User1, User2, User3, User4, User5). User1 and User4 have payment approval privileges and User2 has payment authorization privileges. User3 has neither payment approval nor payment authorization privileges. User5 has both payment approval and payment authorization privileges.

Customer ABC Inc.: User list

| User name | Password | Privileges |
|---|---|---|
| User1 | 1234 | Approval: Yes |
| | | Authorization: No |
| User2 | 9876 | Approval: No |
| | | Authorization: Yes |
| User3 | 7656 | Approval: No |
| | | Authorization: No |
| User4 | 5656 | Approval: Yes |
| | | Authorization: No |
| User5 | 4321 | Approval: Yes |
| | | Authorization: Yes |

As a variant, invoices issued by the biller are assigned to different categories. For example, the categories may be based on the type of product/service offered by the biller or on the amounts of the invoice amongst others. In this variant, each user identifier is associated to respective privileges defining stages which the user is permitted to complete for an invoice in a given category. The table below is a representation of an entry in the customer database for customer DEF INC. providing user privileges on the basis of category. As shown, DEF INC. has two records for users (User1, User2). User1 has payment approval privileges for invoices in the category animal stock only. User2 has payment approval privileges for invoices in the commodities category, the luxury items category and the animal stock category. User2 has payment authorization privileges for invoices in the luxury items category and the animal stock category.

Customer DEF Inc.: User list

| User name | Password | Category | Privileges |
|---|---|---|---|
| User1 | 3434 | Commodities | Approval: No |
| | | | Authorization: No |
| | | Luxury items | Approval: No |
| | | | Authorization: No |
| | | Animal Stock | Approval: Yes |
| | | | Authorization: No |
| User2 | 2357 | Commodities | Approval: Yes |
| | | | Authorization: No |
| | | Luxury items | Approval: Yes |
| | | | Authorization: Yes |
| | | Animal Stock | Approval: Yes |
| | | | Authorization: Yes |

As another variant, the system provides a plurality of levels of permission. For example, regarding approval privileges, a first user at the customer site is permitted to approve invoices of up to a first amount limit; a second person is permitted to approve invoices of up a second amount limit, the second amount limit being higher that the first amount limit; a third person is permitted to approve invoices of up a third amount limit, the third amount limit being greater that the second amount limit; and so on. Similarly, a plurality of levels of permissions may be provided for the other stages of the invoice handling process. The number of levels of permissions may vary from one customer to the other without detracting on the spirit of the invention and will generally be determined on the basis of the organizational style of the customer entity. Advantageously, the use of a plurality of levels of permissions allows the invoice presentment and payment remittance system to be better suited to large business environments. More specifically, it is common in large business environments to delegate to senior administrators the responsibility of approving invoices for small expenses such as paper supplies for example. Larger expenses however generally require the authorization of a director or vice president in a business. This feature permits the two systems to be integrated such as automatically differentiate between the two levels of permissions.

It is to be expressly understood that other formats for a customer database 202 are possible without detracting from the spirit of the invention.

The user identifiers and the privileges associated to each are provided by the customer entity 102 to the biller 104 via a registration process.

The invoice database 203 includes for each customer in the customer database 202 a list of invoice entries associated to invoices that are not fully paid. Each invoice entry includes an invoice identifier, an invoice amount, an unpaid amount and a plurality of status data elements defining the processing stage of the invoice. Other data elements may also be present without detracting from the spirit of the invention. In a non-limiting example of implementation, a given invoice is associated to an approval status data element and an authorization status data element. The authorization status data element is indicative of either one of payment authorization and absence of payment authorization by the customer entity. The approval status data element is indicative of either one of payment approval and absence of payment approval by the customer entity. As a variant, the approval status data element is associated to an amount data element indicative of an amount of the invoice which has been approved for payment.

The memory also includes a program element 204 for operating on the data 206 for managing a customer's account as well as tools to allow the biller 104 to manage customer invoices in the invoice database 203 and to provide electronic handling of invoice.

A typical interaction will better illustrate the functioning of the electronic invoice presentment and payment remittance system 100 and of the program elements 204.

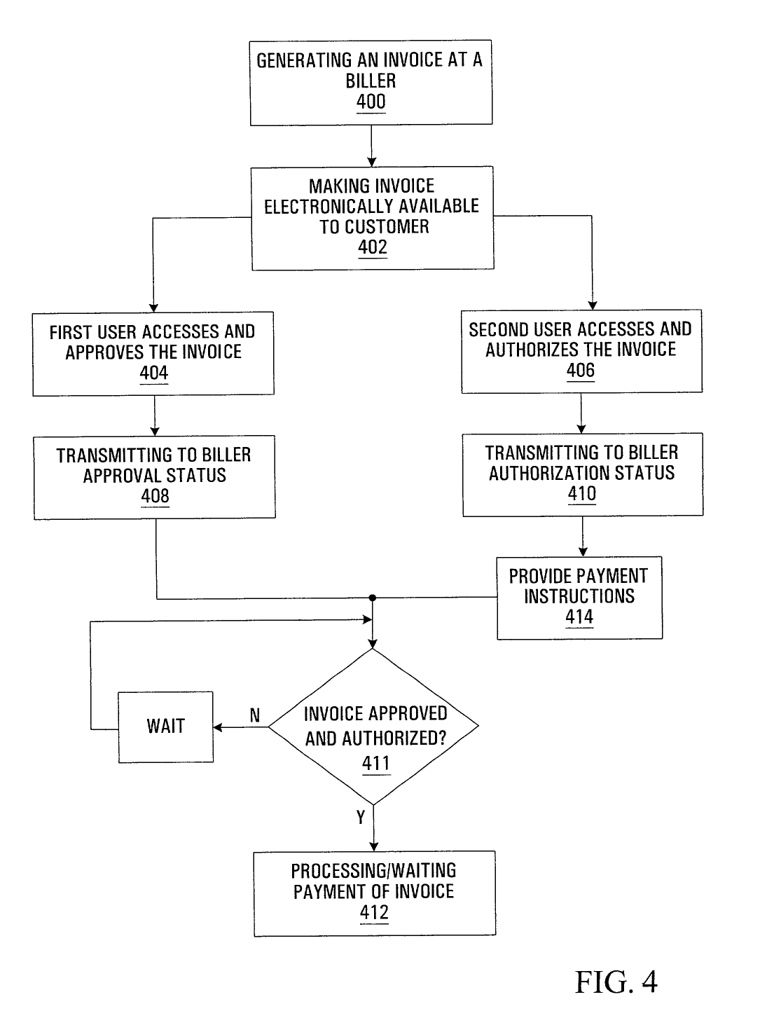

Prior to the use of the electronic invoice presentment and payment remittance system 100, the customer entity 102 registers with the biller entity 104. The registration between the customer entity and the biller entity may be effected over the network 106 or by providing a form to be transmitted by mail, fax or other suitable transmission methods. Registration over the network 106 through a web-based interface will be described herein below with reference to FIG. 3 of the drawings. Registration through the other methods will be readily apparent to the reader skilled in the art. At step 300, a user at the customer site accesses a designated registration website associated with the biller through a network link by providing a network address. This action submits a request for registration of a new customer with the biller entity 104. In response, the customer entity system downloads a registration module implemented by program element 204 (shown in FIG. 2) from the biller computing system 116 to a customer computing unit. The registration module automatically launches to aid the user at the customer site in the completion of the online application for registration. In a specific example of implementation, the registration module is configured to provide step-by-step instructions. At step 302, the user at the customer site fills out a form including various fields related to personal and financial matters, such as company name, address, telephone number, credit card numbers, bank affiliations, and the likes. The user also provides data related to preferred payment methods, a list of authorized user identifiers and passwords as well as the privileges associated to each user identifier. Some of these information fields may be omitted and others added without detracting from the spirit of the invention. At this stage, the user can enable a first user associated to a user identifier to approve invoices and a second user associated to a user identifier to authorize invoices. In order to increase security, the user requesting registration at the customer site provides an indication that he (she) is permitted to register the customer with the biller. This may be effected by providing a prearranged password at the time of registration, by providing a signed document attesting to this, or by some other means. Once the application for registration is completed at step 303, the application for registration is submitted to the biller entity 104. The registration module facilitates this communication between the customer entity 102 and the biller entity 104. The application form itself, or the registration module, contains the necessary routing information to direct the application over the network 106 to the biller computing system 116. At step 308, the biller entity 104 reviews the application for registration to determine whether the customer entity 102 should be permitted to register and whether any information is missing. If registration is denied, for example information is missing, the customer entity is already registered or the user requesting registration does not have the permission to do so, at step 312 the biller entity 104 returns a message to the customer entity 102 indicating that the application for registration has been denied. Conversely, if the application is granted, the biller entity 104 may return a message indicating that the application for registration is successful.

Assuming that the application for registration is granted, at step 310 the biller computing system 116 at the biller entity 104 creates a customer account entry in the customer database 202 including a customer identifier and a plurality of records. Each record associated to the customer identifier includes an authorized user name, password and associated privileges. In a specific implementation, the customer entity entry in the customer database includes at least one record where a first user is associated with payment approval privileges and a second record where a second user is associated with payment authorization privileges. A link between the customer account entry in the customer database 202 is associated to an entry in the invoice database 203. In a specific implementation, the program element further provides functionality for allowing a user at the consumer entity to modify the entries in the consumer database such as to add/remove authorized user identifiers, modify passwords, modify privileges and so on. Following this, the registered customer may handle invoices over the network 106.

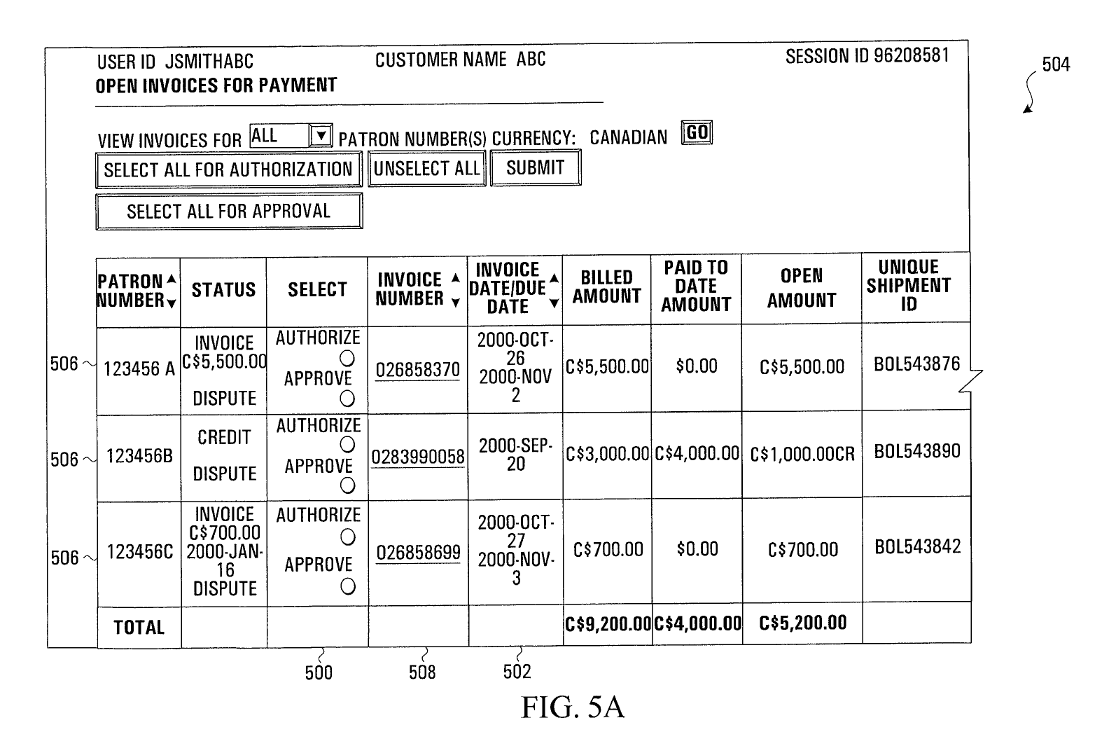

FIGS. 4 is a flow diagram of a process for electronically presenting and granting payment of invoices in accordance with specific examples of implementation of the invention.

With reference to FIG. 4, at step 400, the biller computing system 116 generates an invoice at the biller entity. The invoice is stored in the invoice database 203 and is association with a customer account entry in the customer database 202. The status data elements defining the processing stage of the invoice are also set at this stage. In a non-limiting example, the authorization status data element is indicative of an absence of payment authorization and the approval status data element is indicative of an absence of payment approval.

At step 402, the invoice is made electronically available to the customer entity. In a first non-limiting example of implementation, the invoice is transmitted via e-mail to the first and second users at the customer entity. In this implementation, the invoice is provided as a data structure including an approval field and an authorization field, the approval and authorization fields being modifiable by the first and second users respectively. In a non-limiting example, a field is provided allowing the second user to provide payment remittance information credit card information, an authorization to debit a bank account, wire transfer information, direct deposit information or an indication that a check will be mailed.

In a second non-limiting example of implementation, the invoice is made electronically available over network 106 by providing a designated website. In a non-limiting example, the website is a secure website implementing an electronic invoice payment system. Authorized users associated with the customer entity can access the site in order to perform designated tasks.

In a second specific example of implementation, the invoice is electronically transmitted over the Internet. In a non-limiting example of implementation, in order to view invoices and other account information, the users associated with the customer entity log on to a secure web-site using login names and associated passwords. The account information is displayed on a graphical user interface on the customer's computer terminal. Each unpaid invoice is displayed with an approval field and an authorization field. The approval and authorization fields are modifiable by the first and second users respectively where the first user has payment approval privileges and the second user has payment authorization privileges. In a non-limiting example, a field is provided allowing the second user to provide payment remittance information including credit card information, an authorization to debit a bank account, wire transfer information, direct deposit information or an indication that a check will be mailed.

In a typical interaction, users associated to the customer entity access a designated website through a network link by providing a network address in order to view invoices and other account information. The users log on to the secure website by providing login information including a customer identifier, a login name and a password. The biller computing system received the login information and processes it with respect to the customer database 202. More specifically, the processor 208 accesses the customer database 202 to locate the entry corresponding to the customer identifier. If no corresponding entry is found, an error message is returned to the customer entity. If a corresponding entry is found, the processor 208 attempts to locate a record corresponding to the login name provided. If no corresponding record is found, an error message is returned to the user. If a corresponding record is found, the password in the record is compared to the password provided in the login information. If a match is not found, an error message is returned to the user. If a match is found, the user is successfully identified.

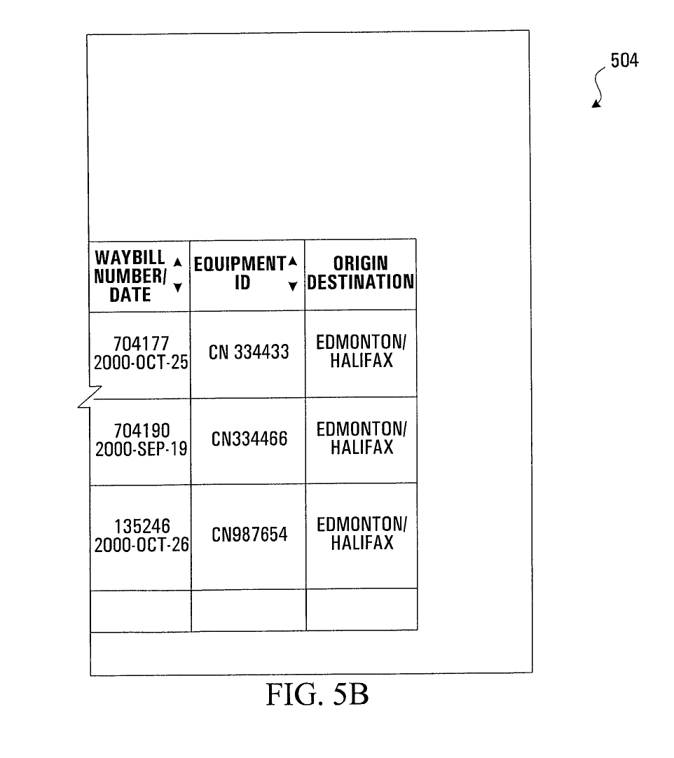

Once a user is successfully identified, the account information in the invoice database 203 corresponding to the customer identifier is transmitted to the user's terminal for display on a graphical user interface at the user's computer terminal. The graphical user interface provides the user with the ability to view one or more outstanding invoices associated with the biller entity 104. FIGS. 5a and 5b of the drawings depicts a graphical user interface showing 3 unpaid invoices in a table 504. Each invoice is depicted as a row 506 in the table 504, each invoice being associated to various information data elements describing characteristics of the invoice. In a non-limiting example, the graphical user interface provides a link for accessing an electronic copy of the complete invoice. In the graphical user interface shown in FIGS. 5a and 5b, this is effected by providing a link associated to the invoice number in the invoice number column 508. When activating a link in the invoice number column 508, a corresponding invoice is displayed to the user at the customer entity site. In a non-limiting implementation, each invoice is provided with a selection column 500 allowing the user to approve or to authorize payment of an invoice by checking a box.

Continuing the typical interaction, at step 404, a first user accesses the designated website in the manner described above, where the first user has payment approval privileges in the customer database but does not have payment authorization privileges. Once the first user has viewed a certain invoice there is the choice of approving the invoice for payment or authorizing the payment to take place or to do none of the above.

In a first embodiment, the first user enters in the selection column 500 instructions to approve the invoice by checking a box or filling in a field. At step 408, the instructions are sent to the biller entity over the network 106. The biller entity processes the instructions received from the first user. More specifically, the biller system determines whether the first user was associated to the appropriate permissions in the customer database 202 to be permitted to issue the instructions. For example, if the first user checks the box associated to payment authorization, the biller system will check in the customer database if the first user has payment authorization privileges. Since the first user has payment approval privileges but does not have payment authorization privileges, the biller system will return an error message to the first user indicating that the instructions are being disregarded. If the first user checks the box associated to payment approval, the biller system will check in the customer database if the first user has payment approval privileges. Since the first user has payment approval privileges, the biller system will mark the invoice in the invoice database as being approved.

In a second embodiment, the graphical user interface is conditioned on the basis of the privileges associated to the user. For example, if the user accessing the system has payment approval privileges, then only the field(s) associated to the approval of the invoice is (are) active with the other fields being deactivated or alternatively being completely absent. The first user enters in the selection column 500 instructions to approve an invoice by checking a box. At step 408, the instructions are sent to the biller entity over the network 106. The biller entity processes the instructions received from the first user. In this embodiment, the biller entity processes the instructions received from the first user to modify the status data element associated to the invoice in the invoice database accordingly. However, since only the boxes associated to permitted actions are active, the biller system, upon receipt of an instruction, does not need to check if the first user was permitted to issue payment approval if this invoice.

Continuing the typical interaction, at step 406, a second user accesses the designated website in the manner described above, where the second user has payment authorization privileges in the customer database but does not have payment approval privileges. It is to be noted that in this specific example of implementation, the second user can access the designated website prior to, simultaneously with or subsequent to the first user. For each invoice, the second user is presented with the fields for approving the invoice for payment, authorizing the payment to take place or to do none of the above.

In a variant, the second user associated to the customer entity is enabled to authorize payment of the invoice when the second user is associated to authorization privileges and the approval status data element is indicative of payment approval. Accordingly, in this specific variant, the second user is enabled to authorize payment of the invoice subsequent the data element transmitted by the first user and indicating that payment of the invoice has been approved is received at the biller.

In the first embodiment, the second user enters in the selection column 500 instructions to approve or to authorize payment of an invoice by checking a box. At step 410, the instructions are then sent to the biller entity over the network 106. The biller entity processes the instructions received from the second user. More specifically, the biller system determines whether the second user was associated to the appropriate permissions in the customer database 202 to issue the instructions in a similar fashion as that described in connection with the first user. If the second user checks the box associated to payment authorization, the biller system will modify the status data element associated to the invoice in the invoice database accordingly.

In a second embodiment, the graphical user interface is conditioned on the basis of the privileges associated to the user. The second user enters in the selection column 500 instructions to authorize an invoice by checking a box. At step 410, the instructions are sent to the biller entity over the network 106. The biller entity processes the instructions received from the second user. In this embodiment, the biller entity processes the instructions received from the second user to modify the status data element associated to the invoice in the invoice database accordingly. However, since only the boxes associated to permitted actions are active, the biller system, upon receipt of an instruction, does not need to check if the second user was permitted to issue payment authorization of the invoice.

In a non-limiting example of implementation, subsequent to the second user issuing a payment authorization instruction, a payment module automatically launches to aid the second user in the completion of the online payment authorization stage 414. In a specific example of implementation, the payment module is configured to provide step-by-step instructions. The second user fills out a form including various fields related to payment instructions. The authorization stage may include providing the biller with a credit card number, with an authorization to debit a bank account, wire transfer information, direct deposit information or simply an indication that the check will be mailed on a certain day. The information regarding the payment instructions is submitted to the biller entity over the network 106. The biller entity receives the payment instructions. Alternatively, default payment instructions may be provided by the customer at the time of registration or subsequently indicate a default manner of paying invoices. In this alternative, step 414 may be omitted.

At step 411, the biller computing unit verifies if an invoice in the invoice database has been both approved and authorized. In the affirmative, the biller computing system 116 processes or waits for payment of the invoice in a conventional manner on the basis of the payment instructions provided by the customer.

Although the detailed description describes extensively a system for electronically presenting and granting payment of invoices where the invoices are accessible via a web based interface, other embodiments are possible. For example, invoices may be sent to first and second users at the customer entity via electronic mail, the first user having payment approval privileges and the second user having payment authorization privileges. At the customer site, the first and second users open the received electronic mail and the account information contained therein is displayed on a graphical user interface on the users' computer terminals. The processing of the invoice at the biller site may be effected in a similar fashion as that described above. In the case of the transmission of an invoice by e-mail, having a graphical user interface conditioned on the basis of the privileges associated to the users to whom the e-mail is sent will result in fewer e-mail transmissions between the customer entity and the biller.

Although the present invention has been described in considerable detail with reference to certain preferred embodiments thereof, variations and refinements are possible without departing from the spirit of the invention. Therefore, only the appended claims and their equivalents should limit the scope of the invention.

1) A method for electronically presenting and granting payment of invoices comprising:
a) generating an invoice at a biller;
b) making the invoice electronically available to a customer entity;
c) enabling a first user associated to the customer entity to approve the invoice;
d) enabling a second user associated to the customer entity to authorize payment of the invoice, the second user being distinct from the first user;
e) transmitting over a network from the first user to the biller a data element indicating that payment of the invoice has been approved;
f) transmitting over a network from the second user to the biller a data element indicative that payment of the invoice has been authorized;
g) detecting granting of payment of the invoice at the biller when payment of the invoice has been approved and authorized.

2) A method as described in claim 1, wherein the second user is enabled to authorize payment of the invoice subsequent the data element indicating that payment of the invoice has been approved being received at the biller.

3) A method as described in claim 1, further comprising electronically transmitting the invoice over a network.

4) A method as described in claim 3, further comprising electronically transmitting the invoice over the Internet.

5) A method as described in claim 1, wherein the first user has payment approval privileges and the second user has payment authorization privileges.

6) A method as described in claim 5, further comprising preventing a given user having neither payment approval privileges nor payment authorization privileges from accessing the invoice.

7) A method as described in claim 5, wherein the first user and the second user reside in geographically remote locations.

8) A method as described in claim 1, said method further comprising:
a) processing an identifier associated with the first user to determine if the first user has payment approval privileges;
b) preventing the processing of payment of the invoice if the first user does not have payment approval privileges.

9) A method as described in claim 8, said method further comprising:
a) processing an identifier associated with the second user to determine if the second user has payment authorization privileges;
b) preventing the processing of payment of the invoice if the second user does not have payment authorization privileges.

10) A method as described in claim 1, said method further comprising enabling the second user to provide payment remittance information including data selected from the set consisting of a credit card number, an authorization to debit a bank account, wire transfer information, direct deposit information and an indication that a check will be mailed.

11) A method as described in claim 1, wherein the invoice is associated to given category selected from a plurality of categories, the first user having respective privileges associated to respective categories, the first user having payment approval privileges associated to the given category selected from a plurality of categories.

12) A method as described in claim 11, wherein the second user has respective privileges associated to respective categories, the second user having payment authorization privileges associated to the given category selected from a plurality of categories.

13) A computer-readable medium comprising computer-executable instructions for:
a) storing an invoice at a biller entity;
b) making the invoice electronically available to a customer entity;
c) enabling a first user associated to the customer entity to approve the invoice;
d) enabling a second user associated to the customer entity to authorize payment of the invoice, the second user being distinct from the first user;
e) transmitting from the first user to the biller entity a data element indicative that payment of the invoice has been approved;
f) transmitting from the second user to the biller entity a data element indicative that payment of the invoice has been authorized;
g) detecting granting of payment of the invoice at the biller entity when payment of the invoice has been approved and authorized.

14) A computer-readable medium as described in claim 13, having further computer-executable instructions for enabling the second user to specify payment instructions including an amount to be paid on the invoice.

15) A computer-readable medium as described in claim 14, having further computer-executable instructions for presenting the invoice to the customer entity through a graphical user interface.

16) A computer-readable medium as described in claim 13, wherein the second user is enabled to authorize payment of the invoice subsequent the data element indicating that payment of the invoice has been approved being received at the biller.

17) A method for granting payment of an invoice over a network, the invoice having been issued by a biller entity to a customer entity, said method comprising:
a) transmitting a first data element indicating that payment of the invoice has been approved by a first user associated to the customer entity to the biller;
b) transmitting a second data element indicating that payment of the invoice has been authorized by a second user associated to the customer entity to the biller entity;
payment of the invoice being granted by the customer entity when the first data element and the second data element have been transmitted to the biller, indicating that the invoice has been approved and authorized.

18) A method as described in claim 17, wherein said method further comprises:
a) processing an identifier associated with the first user to determine if the first user has payment approval privileges;
b) precluding granting of payment of the invoice if the first user does not have payment approval privileges.

19) A method as described in claim 18, wherein said method further comprises:
a) processing an identifier associated with the second user to determine if the second user has payment authorization privileges;
b) precluding granting of payment of the invoice if the second user does not have payment authorization privileges.

20) A method as described in claim 19, wherein the second user is distinct from the first user.

21) A method as described in claim 20, wherein the network is a global computer network.

22) A method as described in claim 21, wherein the first user and the second user reside in geographically remote locations and are associated to a first computer terminal and a second computer terminal respectively, each of said first computer terminal and said second computer terminal having a respective link established between itself and a computing apparatus associated to the biller entity.

23) A method as described in claim 17, said method further comprises transmitting from the second user a data element selected from the set consisting of a credit card number, an authorization to debit a bank account, wire transfer information, direct deposit information and an indication that a check will be mailed.

24) A method as described in claim 17, wherein the first user has payment approval privileges and the second user has payment authorization privileges.

25) A method as described in claim 17, wherein the invoice is associated to given category selected from a plurality of categories, the first user having respective privileges associated to respective categories, the first user having payment approval privileges associated to the given category selected from a plurality of categories.

26) A method as described in claim 25, wherein the second user has respective privileges associated to respective categories, the second user having payment authorization privileges associated to the given category selected from a plurality of categories.

27) A method for handling an invoice over a network, the invoice having been issued by a biller entity to a customer entity, said method comprising:
a) receiving over the network at a biller entity a first instruction data element for modifying an approval status data element associated to the invoice;
b) receiving over the network at a biller entity a second instruction data element for modifying an authorization status data element associated to the invoice,;
c) detecting granting of payment of the invoice at the biller entity when:
i) the approval status data element is indicative of payment approval; and
ii) the authorization status data element is indicative of payment authorization.

28) A method as described in claim 27, wherein said authorization status data element is indicative of either one of payment authorization or absence of payment authorization by the customer entity.

29) A method as described in claim 28, wherein said approval status data element is indicative of either one of payment approval or absence of payment approval by the customer entity.

30) A method as described in claim 27, wherein the first instruction data element is associated to a first user, said method further comprising:
a) processing an identifier associated with the first user to determine if the first user has payment approval privileges;
b) preventing the detection of the granting of payment if the first user does not have payment approval privileges.

31) A method as described in claim 30, wherein the second instruction data element is associated to a second user, said method further comprising:
a) processing an identifier associated with the second user to determine if the second user has payment authorization privileges;
b) preventing the detection of the granting of payment if the second user does not have payment authorization privileges.

32) A method as described in claim 31, wherein the first user and the second user reside in geographically remote locations.

33) A method as described in claim 32, wherein the network is a global computer network.

34) A method as described in claim 27, wherein said method further comprises receiving at said biller entity a data element selected from the set consisting of a credit card number, an authorization to debit a bank account, wire transfer information, direct deposit information and an indication that a check will be mailed.

35) A computer readable medium comprising a program element suitable for execution by a computing apparatus for processing an invoice over a network, the invoice being issued by a biller entity to a customer entity, said computing apparatus comprising:
a) a memory unit;
b) a processor operatively connected to said memory unit, said program element, when executing on said processor, being operative for:
i) receiving a first data element associated to the invoice, the first data element indicating that payment of the invoice has been approved;
ii) receiving a second data element associated to the invoice, the second data element indicating that payment of the invoice has been authorized;
iii) detecting granting of payment of the invoice when the first data element and the second data element have been received, indicating that the invoice has been approved and authorized.

36) A computer readable medium as described in claim 35, wherein said second data element is indicative of either one of payment authorization and absence of payment authorization by the customer entity.

37) A computer readable medium as described in claim 36, wherein said first data element is indicative of either one of payment approval and absence of payment approval by the customer entity.

38) A computer readable medium as described in claim 35, wherein said memory unit is for storing an entry associated to the customer entity, the entry including at least one record, the record having an identifier associated to a user of a first type, the user of a first type having payment approval privileges, said program element when executing on said processor being operative for:
i) receiving a first user identifier associated to a first user having issued said first data element;
ii) processing said first user identifier at least on part on the basis of the identifier in the record to determine whether the first user has payment approval privileges;
iii) preventing the detection of the granting of payment if the first user does not have payment approval privileges.

39) A computer readable medium as described in claim 38, wherein the entry further comprises a second record having an identifier associated to a user of a second type, the user of a second type having payment authorization privileges, said program element, when executing on said processor, being operative for:
i) receiving a second user identifier associated to a second user having issued said second data element;
ii) processing said second user identifier at least on part on the basis of the identifier in the record to determine whether the second user has payment authorization privileges;
iii) preventing the detection of the granting of payment if the first user does not have payment authorization privileges.

40) A computer readable medium as described in claim 35, said program element, when executing on said processor, being further operative for receiving a data element selected from the set consisting of a credit card number, an authorization to debit a bank account, wire transfer information, direct deposit information and an indication that a check will be mailed.

41) An electronic invoice presentment and payment remittance system including a network, a biller computing unit with computer-readable medium, a first customer computing unit with computer readable medium, a second customer computing unit with computer readable medium, the computer-readable media having computer-executable instructions for:
a) operatively linking the biller computing unit and customer computing unit to the network;
b) generating an invoice at the biller computing unit;
c) making the invoice electronically available to the first customer computing unit over the network;
d) facilitating entry of approval instructions at the first customer computing unit and following said entry, routing the approval instructions to the biller computing unit;
e) making the invoice electronically available to the second customer computing unit over the network;
f) facilitating entry of authorization instructions at the second customer computing unit and following said entry, routing the authorization instructions to the biller computing unit;
g) detecting granting of payment of the invoice at the biller entity when the following conditions are satisfied:
i) the approval instructions from the first customer computing unit indicate that the invoice has been approved; and
ii) the authorization instructions from the second customer computing unit indicate that the invoice has been authorized.

42) A system as described in claim 41, wherein the computer readable media has computer executable instructions for facilitating entry at the second customer computing unit of payment instructions, including data selected from the set consisting of a credit card number, an authorization to debit a bank account, wire transfer information, direct deposit information and an indication that a check will be mailed.

43) A system as described in claim 42, wherein the payment instructions include a payment amount.

44) A system as described in claim 41, wherein the invoice is made electronically available to the second customer computing unit subsequent the receipt of approval instructions at the biller computing unit, the approval instructions from the first customer computing unit indicating that the invoice has been approved.

45) A system for electronically presenting and granting payment of invoices, said system comprising:
a) means for generating an invoice at a biller;
b) means for making the invoice electronically available to a customer entity;
c) means for enabling a first user associated to the customer entity to approve the invoice;
d) means for enabling a second user associated to the customer entity to authorize payment of the invoice, the second user being distinct from the first user;
e) means transmitting from the customer entity back to the biller entity a data element indicative that payment of the invoice has been approved;
f) means for transmitting from the customer entity back to the biller entity a data element indicative that payment of the invoice has been authorized;
g) means for detecting granting of payment of the invoice at the biller when payment of the invoice has been approved and authorized.

46) A method for electronically presenting and granting payment of invoices comprising:
a) generating an invoice at a biller;
b) making the invoice electronically available to a customer entity;
c) enabling a plurality of users associated to the customer entity to complete respective stages of a multi-stage invoice handling process;
d) transmitting to the biller from said plurality of users data elements indicating that respective stages of the a multi-stage invoice handling process have been completed;
e) detecting granting of payment of the invoice at the biller when the data elements, indicative that respective invoice processing stages have been completed, are received at the biller and indicate that the multi-stage invoice handling process has been completed.

47) A method as defined in claim 46, wherein the multi-stage invoice handling process includes a first stage and a second stage, said method further comprising:
a) enabling a first user to complete the first stage;
b) enabling a second user to complete the second stage subsequent the data element indicating that the first stage has been completed being received at the biller.
